(19) United States
(12) Patent Application Publication
(10) Pub. No.: US 2023/0177218 A1
(43) Pub. Date: Jun. 8, 2023

(54) ENABLING DEVICE SECURITY BY DESIGN ENUMERATION SELECTIVE TARGETING

(71) Applicant: International Business Machines Corporation, Armonk, NY (US)

(72) Inventors: Scott David Halle, Slingerlands, NY (US); Shawn Peter Fetterolf, Cornwall, VT (US); Gauri Karve, Cohoes, NY (US); Kangguo Cheng, Schenectady, NY (US); Alex Joseph Varghese, BALLSTON LAKE, NY (US); Derren Neylon Dunn, Sandy Hook, CT (US)

(21) Appl. No.: 17/545,327

(22) Filed: Dec. 8, 2021

(51) Int. Cl. G06F 21/71; G06F 30/398

(52) U.S. Cl. CPC G06F 21/71; G06F 30/398

(57) ABSTRACT

A computer-implemented method of ensuring integrity of an integrated circuit (IC) is provided. The computer-implemented method includes providing a design layer that meets design rule checks (DRCs), identifying a first critical dimension (CD) distribution of the design layer and using retargeting shapes in the design layer to enable a biasing of CDs of targets to enable a provision of two different CD distributions, which are DRC clean and which are separate from one another and which cannot be expressed by a single Gaussian distribution.

### BACKGROUND

The present invention generally relates to device security, and more specifically, to enabling device security by design enumeration selective targeting.

The fabrication of advanced integrated circuits (ICs) is often carried out by foundries, which may not always be trustworthy. In some instances, the manufactured chips may be modified as compared to the initial design (that is, tampered with) by adding “malicious circuitry” or deleting circuits that can open security issues and/or lead to reliability problems, controlled malfunctioning and the like. Alterations may be introduced at the silicon manufacturing level, back end of the line wiring level, and/or at the packaging level. These “inserted” or “deleted” circuits cannot be detected through regular electrical screening tests, because they are designed to hide themselves from such tests.

### SUMMARY

Embodiments of the present invention are directed to a computer-implemented method of ensuring integrity of an integrated circuit (IC). A non-limiting example of the computer-implemented method includes providing a design layer that meets design rule checks (DRCs), identifying a first critical dimension (CD) distribution of the design layer and using retargeting shapes in the design layer to enable a biasing of CDs of targets to enable a provision of two different CD distributions, which are DRC clean and which are separate from one another and which cannot be expressed by a single Gaussian distribution.

Embodiments of the present invention are directed to a computer-implemented method of designing semiconductor chip layers. A non-limiting example of the computer-implemented method includes designing semiconductor chip layers that meet design rule checks (DRCs) to form a device with a characteristic property and enumerating objects of the device to assign a retargeting operation to respective locations of each of the objects to adjust the characteristic property.

Embodiments of the invention are directed to a semiconductor chip. A non-limiting example of the semiconductor chip includes a grid and an array of elements electrically coupled to the grid according to a design that meets design rule checks (DRCs) to form a device. The array of elements include a first group of elements having similar physical characteristics and a second group of elements having physical characteristics that differ from those of the first group of elements such that the device has two different critical dimension (CD) distributions separated from each other and that cannot be described by a single Gaussian expression.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1A depicts a high-level optimization process accounting for both virtual fabrication and virtual technology processes in accordance with one or more embodiments of the present invention;

FIG. 1B is a schematic diagram of a processing circuit capable of executing mask-design algorithms in accordance with one or more embodiments of the present invention;

FIG. 2A is a top-down view of a device with an array of elements in accordance with one or more embodiments of the preset invention;

FIG. 2B is a graphical depiction of a critical dimension (CD) distribution for the device of FIG. 2A in accordance with one or more embodiments of the present invention;

FIG. 3A is a top-down view of a device with an array of elements, some having been modified, in accordance with one or more embodiments of the preset invention;

FIG. 3B is a graphical depiction of a critical dimension (CD) distribution for the device of FIG. 3A in accordance with one or more embodiments of the present invention;

FIG. 4 is a plan view of a semiconductor chip with modified elements in accordance with one or more embodiments of the present invention;

FIG. 5 is a flow diagram illustrating a computer-implemented method of ensuring integrity of an integrated circuit (IC) in accordance with one or more embodiments of the present invention; and

FIG. 6 is a flow diagram illustrating a computer-implemented method of designing semiconductor chip layers in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, a trusted supply chain for manufacturing a semiconductor chip ensures the secure integrity of the semiconductor chip. This is essential in order to ensure that functionalities of semiconductor chips are not tampered with and to thereby prevent the addition of malicious functions. However, because a semiconductor chip manufacturing supply chain can be compromised at one or more stages between “trusted” design/photomask production facilities and chip packaging facilities, it is possible that a semiconductor chip could fall into the custody of a “non-trusted” facility, such as a “non-trusted” foundry. In such cases, when “non-trusted” foundry operations are used in the supply chain, the secure integrity of a semiconductor chip may not be ensured and alternate methods of ensuring integrity may be required to guard against efforts at tampering with the secure integrity of the semiconductor chip.

In conventional semiconductor chip designs, alternate methods of ensuring integrity include the use of desired and trusted security keys and unique codes that are extracted from some inherent characteristics of device implementations, such as arbiters, ring oscillators, SRAMs, flip-flops and latches. It has been found that such alternate methods can be overcome due various factors such as being able to be replicated from design intent and being dependent on inherent fabrication processes.

Turning now to an overview of the aspects of the invention, one or more embodiments of the invention address the above-described shortcomings of the prior art by providing for the fabrication of trusted hardware in a semiconductor chip by engineering mask design operations to provide unique signatures to devices within the chip, which cannot be replicated from design intent. The fabrication of the trusted hardware does not depend on inherent fabrication process distributions, but rather is embodied in a subtle variation to the design that is difficult to detect. This is achieved by algorithmic randomization of an upsizing of a critical dimension of a designated structure (e.g., contacts in an array of contacts) in a design whereby a unique resistance distribution can be generated for each device array. This algorithmic randomization can be achieved by selective retargeting using a design enumeration approach.

The above-described aspects of the invention address the shortcomings of the prior art by providing a computer-implemented method of ensuring integrity of an integrated circuit (IC). The computer-implemented method includes providing a design layer that meets design rule checks (DRCs), identifying a first critical dimension (CD) distribution of the design layer and using retargeting shapes in the design layer to enable a biasing of CDs of targets to enable a DRC clean second CD distribution, which differs from the first CD distribution.

Turning now to a more detailed description of aspects of the present invention, in designing an integrated circuit (IC) device, engineers or designers typically rely on computer design tools to help create an IC schematic or design, which can include a multitude of individual devices, such as transistors, coupled together to perform certain functions. To actually fabricate the IC device in or on a semiconductor substrate, the IC device schematic must be translated into a physical representation or layout, which itself can then be transferred onto the semiconductor substrate. Computer aided design (CAD) tools can be used to assist layout designers with translating the discrete circuit elements into shapes, which will embody the devices themselves in the completed IC device. These shapes make up the individual components of the circuit, such as gate electrodes, diffusion regions, metal interconnects and the like.

The software programs employed by the CAD systems to produce layout representations are typically structured to function under a set of predetermined design rules in order to produce a functional circuit. Often, the design rules are determined by certain processing and design limitations based roughly on the patternability of layout designs. For example, design rules may define the space tolerance between devices or interconnect lines. Once the layout of the circuit has been created, the next step in manufacturing the IC device is to transfer the layout onto the semiconductor substrate. Optical lithography or photolithography is a well-known process for transferring geometric shapes onto the surface on a semiconductor wafer. Photolithography generally begins with the formation of a photoresist layer on the top surface of a semiconductor substrate or wafer. A reticle or mask having certain transmissive regions (e.g., fully light non-transmissive opaque regions such as those formed of chrome, fully light transmissive clear regions such as those formed of quartz, partially transmissive, trilayer, etc.) is then positioned over the photoresist coated wafer.

The mask is placed between a radiation or light source, which can produce light of a pre-selected wavelength (e.g., ultraviolet light) and geometry, and an optical lens system, which may form part of a stepper apparatus. When the light from the light source is directed onto the mask, the light is focused to generate a reduced mask image on the wafer, typically using the optical lens system, which may contain one or several lenses, filters and/or mirrors. This light passes through the clear regions of the mask to expose the underlying photoresist layer, and is blocked by the opaque regions of the mask, leaving that underlying portion of the photoresist layer unexposed. The exposed photoresist layer is then developed, typically through chemical removal of the exposed or unexposed regions of the photoresist layer. The end result is a semiconductor wafer coated with a photoresist layer exhibiting a desired pattern, which defines the geometries, features, lines and shapes of that layer. This pattern can then be used for etching of or controlling deposition into underlying regions of the wafer.

Layout enumeration can be used to facilitate IC development by leveraging restricted design rules and the growing robustness of manufacturing simulations in order to validate ground rules. Briefly stated, a more complete and exhaustive enumeration of all allowed topologies out to an optically significant radius is generated, with the corresponding layout configurations then run through a suitable manufacturing simulation to validate that solutions exist for all supported layouts, to rule out common features of failing layouts and to drive solutions for important configurations that have high design value.

The process starts with a minimal set of basic placement rules specifying a coarse placement grid and directions for each layer, allowed wire widths and minimum widths and spaces, all of which may be obtained conventionally. This defines an abstract base of a few patterns. Next, a small region of interest is defined, with a single layer (and optionally some layer above or below) being examined. Because of the coarse grid, it is possible to enumerate all allowed layouts on the target layer in this region, and to then run a manufacturability analysis on each. This will initially identify some layouts as non-manufacturable using the current assumptions. Then, triage is used to determine whether the manufacturability can be improved by considering other technology options (e.g., different mask generation or lithographic algorithms). If not, the failing layouts can be analyzed to determine what features they have in common in order to construct new forbidden patterns.

The new forbidden pattern rules are then added to a database of patterns and the process is repeated with a larger region (radius) of interest. Progressively pruning the allowed configurations in this manner helps reduce the growth in the number of layouts to consider. In addition, increasing the range also allows new patterns to be discovered. The process may be stopped once the expected radius of optical interactions is reached, which should correspond with no additional new patterns being found.

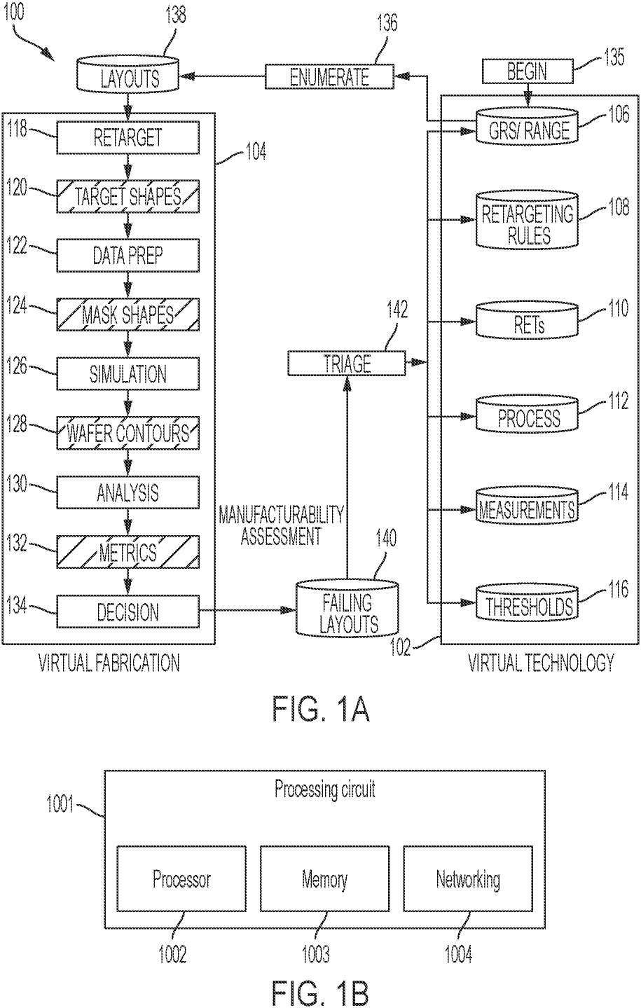

With reference to FIGS. 1A and 1B, a schematic diagram is shown in FIG. 1A to illustrate an optimization process 100 in which the disclosed layout enumeration technique may be used to converge both virtual fabrication and virtual technology processes, in accordance with an embodiment of the invention. That is, the “rule loop” shown in FIG. 1 represents the optimization process 100 for ground rules and other data that represent the technology. FIG. 1 illustrates aspects of both virtual technology 102 and virtual fabrication 104. For example, aspects of virtual technology 102 include ground rules data 106, retargeting rules 108, reticle enhancement techniques (RETs) 110, process data 112, measurement data 114 and threshold data 116. However, it is understood that these are just examples of data that represent integrated circuit technology. Aspects of virtual fabrication are processes and result in output data (shaded blocks) such as, for example, retargeting 118/target shapes 120, data prep 122/mask shapes 124, simulation 126/wafer contours 128, analysis 130/metrics 132 and decision 134. FIG. 1B is a schematic diagram of a processing circuit 1001 by which the optimization process 100 of FIG. 1A is executed.

Beginning at block 135 with an initial set of ground rules 106, layout configurations that adhere to those initial rules are generated through a specific enumeration approach (block 136) described in further detail hereinafter. The database of generated layout configurations 138 are then run through the virtual fabrication process 104, which is collectively used as a manufacturability assessment. That is, the particular flow implemented in the virtual fabrication process 104 ultimately determines whether the input layout configurations 138 thereto are in fact manufacturable. Each non-manufacturable configuration, collectively designated by the failing layouts database 140 in FIG. 1 is assessed through a triage process 142 for its “designability” (i.e., its impact on the design by not having it). If a failing layout is considered high impact, then the process 100 focuses on virtual technology 102 in order to attempt to improve the manufacturability by, for example, adjusting retargeting rules 108, RETs 110, or even unit processes 112. Otherwise, the ground rules 106 are updated to exclude the non-manufacturable configurations from designs. The above process is iterated (using increasing size of constructs) until it converges.

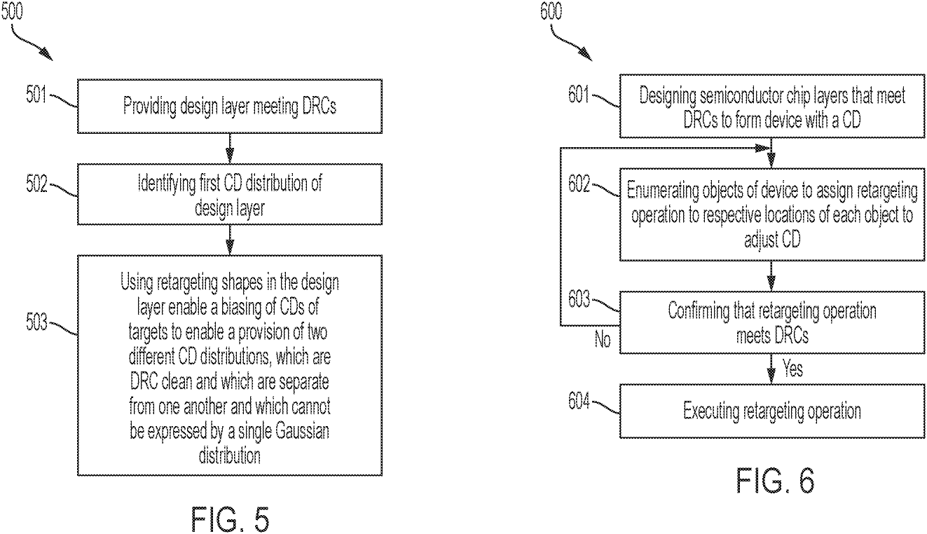

As shown in FIG. 1B, the processing circuit 1001 includes a processor 1002, such as a microprocessor or a central processing unit (CPU) of a computing device, a memory unit 1003 and a networking unit 1004 by which the processor 1002 is communicative with external computing/interface devices. The memory unit 1003 has executable instructions stored thereon that are readable and executable by the processor 1002. These executable instructions include mask-design and other computer-aided design algorithms, which, when read and executed by the processor 1002, cause the processor 1002 to execute at least the optimization process 100 of FIG. 1A and to execute the other operations and functionalities described below (i.e., the method of FIGS. 5 and 6).

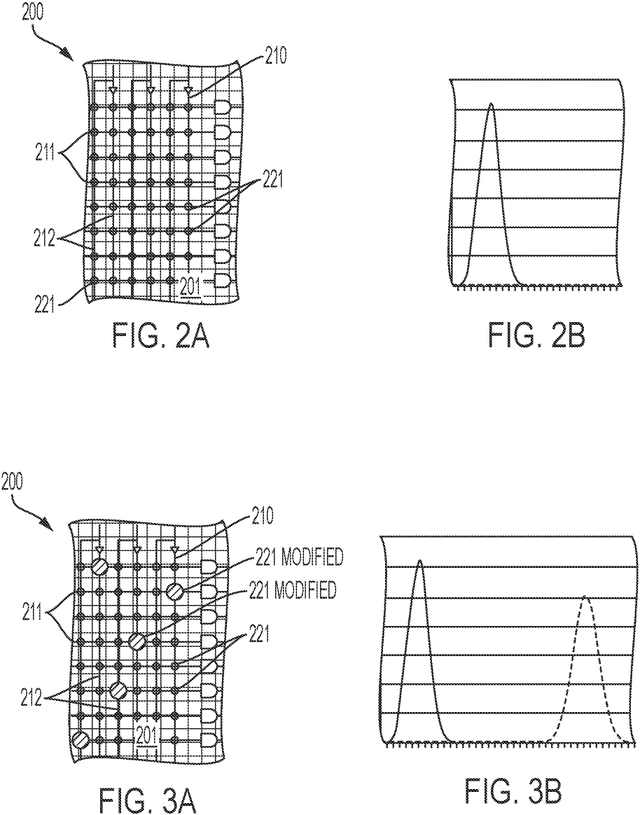

With reference to FIGS. 2A and 2B and with reference to FIGS. 3A and 3B, a semiconductor chip 200 is provided (see FIGS. 2A and 3A) and includes a grid 210 and an array of elements 220. The grid 210 is formed of first, horizontal wires 211 and second, vertical wires 212 that crisscross with the first, horizontal wires 211. The array of elements 220 include elements 221 that are each electrically coupled to the grid 210 at crossing points of the first, horizontal wires 211 and the second, vertical wires 212. The elements 221 are arranged on the grid 210 according to a design that meets design rule checks (DRCs) to form a device 201. The device 201 can be one or more of an arbiter, a ring oscillator, read-access-memory (RAM), a flip-flop, a latch, etc.

As shown in FIG. 2A, at an initial time, each of the elements 221 of the array of elements 220 has similar physical characteristics. They can all be of a similar size and they can all be centrally located at crossing points of the first, horizontal wires 211 and the second, vertical wires 212. With this construction and configuration, the device 201 has a characteristic property (i.e., a device output property) or a critical dimension (CD), such as a characteristic resistance, a characteristic timing and/or a characteristic bit sequence. In the case of the characteristic resistance, each of the elements 221 of the array of elements 220 can be provided as a resistive element whose shape and shape gives the element 221 a characteristic resistance. Thus, while the elements 221 can all have a similar shape and size by design, in practice that are small differences or process variations between each of the elements 221 and the device 201, at the initial time, has a single CD distribution that is inherent to process variation of each of the elements 221 of the array of elements 220. This CD distribution can be expressed as a uni-modal Gaussian distribution and is shown in FIG. 2B.

In accordance with one or more embodiments of the present invention, in order to ensure integrity of the semiconductor chip 200 despite the semiconductor chip 200 possibly being fabricated in part in non-trusted foundries or other facilities, the device 201 can be modified to have two different CD distributions that are separate and that cannot be described by a single Gaussian expression (i.e., the two different CD distributions are controllably non-Gaussian and can be at least bi-modal or tri-modal).

The modification noted above can be executed by modifying the photoresist masks used to form the device 201 during the fabrication process and should pass device rule checks (DRC) so that it is DRC clean and so that the modification will not negatively affect the functionality of the device 201. As shown in FIG. 3A, the modification could involve, for example, upsizing, downsizing and/or moving a group of the elements 221 in the array of elements 220 (the modified elements 221 in FIG. 3A are all upsized for clarity). As such, at a later time, the device 201 will include a first group of elements 221 having similar physical characteristics (i.e., unmodified) and a second group of elements 221 having physical characteristics that are modified and that differ from those of the first group of elements. The device 201 then has two different CD distributions following the modification as shown in FIG. 3B. These two distributions are separate from one another by a significant margin as compared to the respective widths of the distributions themselves and they cannot be described by a single Gaussian expression. That is, the resulting two different CD distributions are controllably non-Gaussian and, in some cases, can be at least bi-modal or tri-modal.

In greater detail, the modification makes use of retargeting marker shapes in a design layer for the semiconductor chip 200 to enable a biasing of CDs of targets to enable DRC clean distributions outside of nominal retargeting. This can results in individual distributions with mean µ1, µ2, µ3 with variance σ, where µ1 - µ2 » σ, µ3 -µ2 » σ. As noted above, a net effect of these CD distributions is the provision of two different CD distributions that are separate from one another and that cannot be described as a single Gaussian expression. Again, the two different CD distributions provide for a controllably non-Guassian (e.g., bi-modal, tri-modal, etc.) expression of the final two different CD distributions.

In accordance with one or more embodiments of the present invention, locations of retargeting marker shapes are controllable by an iterative set of nearest neighbor algorithms, which is sometimes referred to as “design elaboration,” resulting in a random location for shapes on a grid device array. Similarly, sizes of the retargeting marker shapes are also controllable by an iterative set of nearest neighbor algorithms such that, in the case of contacts, neighboring pairs of devices would necessarily have different biases. For each device array on a chip, different enumerations algorithms could control both the placement and the size resulting in unique neighboring pair combinations per location and each mask can have its own unique set of signature device responses for rogue mask detection.

Because the CD distribution of the modified device 201 is controllably non-Gaussian as shown in FIG. 3B and because this CD distribution is highly unlikely to negatively affect a functionality of the device 201 or to arise due to inherent process variations, the CD distribution can be used to ensure that the device 201 has not been tampered with at an untrusted or non-trusted foundry. That is, if the device 201 is produced by a non-trusted foundry in which the device 201 had been tampered with, the CD distribution will not comport with the CD distribution of FIG. 3B and will serve as evidence of the tampering.

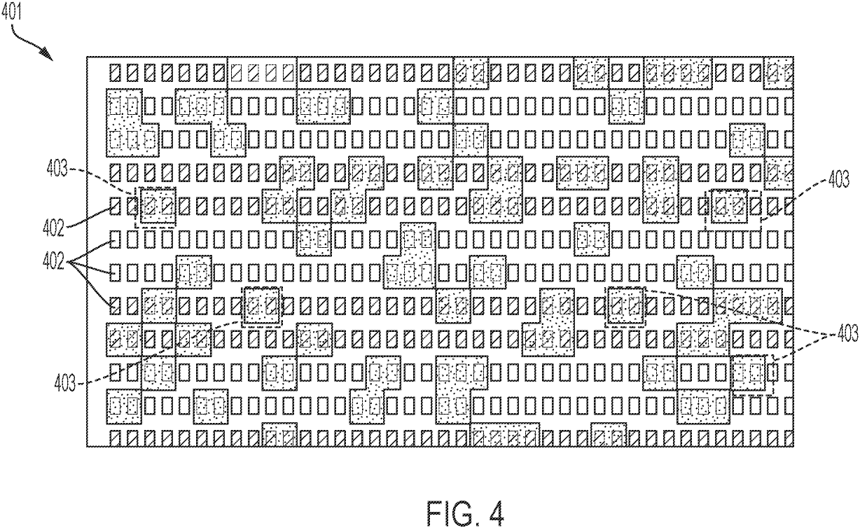

With reference to FIG. 4, a device 401 is shown. The device 401 has been modified by a set of its elements 402 being enumerated for modification and thus upsized to form upsized elements 403. The device 401 is DRC clean and has a controllably non-Gaussian CD distribution that is not a function of inherent process variations of the elements 402.

With reference to FIG. 5, a computer-implemented method 500 of ensuring integrity of an integrated circuit (IC) is provided and is executable by the processing circuit 1001 of FIG. 1A. As shown in FIG. 5, the computer-implemented method 500 includes providing a design layer that meets DRCs (block 501), identifying a first CD distribution of the design layer (block 502) and using possibly randomly sized and/or shaped retargeting marker shapes from possibly randomized locations in the design layer to enable a biasing of CDs of targets to enable the provision of two different CD distributions, which are DRC clean and which are separate from one another and which cannot be expressed by a single Gaussian distribution (block 503). The two different CD distributions are controllably non-Gaussian and differ from the first CD distribution.

With reference to FIG. 6, a computer-implemented method 600 of designing semiconductor chip layers is provided and is executable by the processing circuit 1001 of FIG. 1A. As shown in FIG. 6, the computer-implemented method 600 is similar to the computer-implemented method of FIG. 5 and includes designing semiconductor chip layers that meet DRCs to form a device with a characteristic property such as a CD of the device (block 601). The characteristic property can include a distribution of resistances that are inherent to process variations of each of the elements and could be uni-modal as in FIG. 2B. The method also includes enumerating objects of the device to assign a retargeting operation to respective locations of each of the objects to adjust the characteristic property (block 602) so that the device has a unique signature that is characterized as having two different CD distributions that are separate from one another and that cannot be expressed by a single Gaussian distribution. As noted above, these two different CD distributions could by at least bi-modal as in FIG. 3B or tri-modal and they are controllably non-Gaussian. The method can further includes confirming that the retargeting operation meets the DRCs (block 603) and executing the retargeting operation in an event the retargeting operation meets the DRCs by respectively upsizing, downsizing or moving each of the objects (block 604).

The retargeting operation of operation 604 can include a custom retargeting operation that is applied in addition to or in lieu of a standard foundry retargeting to generate changes to specific arrays or regions of dummy fill on select mask levels. The executing of the retargeting of operation 604 is then processed by optical proximity correction to generate a photolithography mask. This mask is then used to carry out standard photolithography steps followed by process of record patterning processes to transfer altered design shapes to wafer.

The adjustment can involve an adjustment of the characteristic property by modifying one or more of the elements to change a distribution of resistances of the device where the characteristic property of the device prior to the enumerating of operation 601 is a distribution of resistances that are inherent to process variations of each of the elements. Of course, it is to be understood that there are other options for the adjustment that are all based on how the characteristic property or CD is defined. In any case, as a result of the adjustment, the unique signature of the device is not one that would be likely to arise merely as a result of process variations.

In accordance with one or more embodiments of the present invention, the enumerating of operation 602 can involve an addition of a counter to an iterable action in code and returning it in a form of enumerate object. This enumerate object can then be used directly for loops or be converted into a list of tuples using a list() method with a goal to assign retarget operations (ex: upsize/downsize/move) to specific locations in an array (i.e., the array of elements 220 of FIGS. 2A and 3A) without using a rules-based feature selection. The enumerate and output code can be as follows:

Enumerate
# enumerate function in loops
11 = [“CD1”,“CD2”, “CD3,“CD4,”]
# creating enumerate objects
obj 1 = enumerate(11)
# printing the tuples in object directly
for obj 1 in enumerated(11):
print obj 1
print
# changing index and printing separately
for count,obj 1 in enumerate(11,100):
print count,obj 1
OUTPUT : assignment to list of tuples
(0, ‘CD1’)
(1, ‘CD2’)
(2, ‘CD3’)
(3,“CD4”)
100 CD1
101 CD2
102 CD3
103 CD4

As described above with reference to FIGS. 2A and 3A, the device can be provided as one or more of an arbiter, a ring oscillator, read-access-memory (RAM), a flip-flop and a latch and can include or be provided as an array of elements with each of the objects being a corresponding one of the elements with a randomized location within the array.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of ensuring integrity of an integrated circuit (IC), the computer-implemented method comprising:
providing a design layer that meets design rule checks (DRCs);
identifying a first critical dimension (CD) distribution of the design layer; and
using retargeting shapes in the design layer to enable a biasing of CDs of targets to enable a provision of two different CD distributions, which are DRC clean and which are separate from one another and which cannot be expressed by a single Gaussian distribution.

2. The computer-implemented method according to claim 1, wherein the two different CD distributions are controllably non-Gaussian.

3. The computer-implemented method according to claim 1, wherein the using of the retargeting shapes comprises using retargeting shapes from randomized locations.

4. The computer-implemented method according to claim 1, wherein the using of the retargeting shapes comprises randomly resizing the retargeting shapes.

5. A computer-implemented method of designing semiconductor chip layers, the computer-implemented method comprising:
designing semiconductor chip layers that meet design rule checks (DRCs) to form a device with a characteristic property; and
enumerating objects of the device to assign a retargeting operation to respective locations of each of the objects to adjust the characteristic property.

6. The computer-implemented method according to claim 5, further comprising:
confirming that the retargeting operation meets the DRCs; and
executing the retargeting operation in an event the retargeting operation meets the DRCs.

7. The computer-implemented method according to claim 6, wherein the executing of the retargeting operation comprises respectively upsizing, downsizing or moving each of the objects.

8. The computer-implemented method according to claim 5, wherein the characteristic property comprises a critical dimension (CD) of the device and an adjustment of the characteristic property results in a provision of two different CD distributions that are separate from one another and cannot be expressed by a single Gaussian distribution.

9. The computer-implemented method according to claim 8, wherein the device has a unique signature following the adjustment of the characteristic property.

10. The computer-implemented method according to claim 9, wherein the device comprises an array of elements and each of the objects is a corresponding one of the elements.

11. The computer-implemented method according to claim 10, wherein the respective locations of each of the objects are randomized within the array.

12. The computer-implemented method according to claim 10, wherein the device is one or more of an arbiter, a ring oscillator, read-access-memory (RAM), a flip-flop and a latch.

13. The computer-implemented method according to claim 10, wherein:
the characteristic property comprises a distribution of resistances inherent to process variation of each of the elements, and
an adjustment of the characteristic property comprises modifying one or more of the elements to change the distribution of resistances.

14. The computer-implemented method according to claim 13, wherein the distribution of resistances is uni-modal prior to the adjustment of the characteristic property and at least bi-modal following the adjustment of the characteristic property.

15. A semiconductor chip, comprising:
a grid; and
an array of elements electrically coupled to the grid according to a design that meets design rule checks (DRCs) to form a device,
the array of elements forming a device and comprising a first group of elements having similar physical characteristics and a second group of elements having physical characteristics that differ from those of the first group of elements such that the device has two different critical dimension (CD) distributions that are separate and that cannot be described by a single Gaussian expression.

16. The semiconductor chip according to claim 15, wherein the device is one or more of an arbiter, a ring oscillator, read-access-memory (RAM), a flip-flop and a latch.

17. The semiconductor chip according to claim 15, wherein elements of the second group of elements are randomly located in the array of elements.

18. The semiconductor chip according to claim 15, wherein the elements of the array of elements are resistive elements and the second group of elements are upsized, downsized or moved relative to the first group of elements.

19. The semiconductor chip according to claim 18, wherein each of the two different CD distributions is a distribution of resistances inherent to process variation of each of the elements of the array of elements.

20. The semiconductor chip according to claim 18, wherein the two different CD distribution are at least bi-modal.
